(19) United States
(12) Patent Application Publication
(10) Pub. No.: US 2026/0307455 A1
(43) Pub. Date: Oct. 8, 2026

(54) AIR-CONDITIONING CONTROL DEVICE, AIR-CONDITIONING CONTROL METHOD, AND PROGRAM

(71) Applicant: SONY GROUP CORPORATION, TOKYO (JP)

(72) Inventors: RYU TATE, TOKYO (JP); TOSHIHIRO HIRAO, TOKYO (JP); HIROYUKI UEYAMA, TOKYO (JP)

(21) Appl. No.: 18/880,580

(22) PCT Filed: Jul. 10, 2023
(86) PCT No.: PCT/JP2023/025404

§ 371 Date: Jan. 2, 2025

(30) Foreign Application Priority Data
Jul. 25, 2022 (JP) 2022-117762

(51) Int. Cl. B60H 1/00

(52) U.S. Cl. CPC B60H 1/00742

(57) ABSTRACT

The present technology relates to an air-conditioning control device, an air-conditioning control method, and a program for enabling appropriate control of air conditioning in a case where a user has moved from a place where the user stayed into a space where air-conditioning is controlled, such as an interior of a vehicle. The air-conditioning control device according to the present technology includes a parameter calculation unit that calculates an air-conditioning control parameter associated with control of an air-conditioning system, on the basis of stay information that includes a place of stay of a user before the user moves to a space where the air-conditioning system is provided. For example, the present technology is applicable to an air-conditioning control device which controls an air-conditioning system for a vehicle.

### TECHNICAL FIELD

The present technology relates to an air-conditioning control device, an air-conditioning control method, and a program, and particularly to an air-conditioning control device, an air-conditioning control method, and a program for enabling appropriate control of air conditioning, in a case where a user has moved from a place where the user stayed.

### BACKGROUND ART

There has been proposed such a technology which controls a temperature inside a transport such as an automobile and an airplane according to a predicted temperature at a destination of the transport (e.g., see PTL 1).

### CITATION LIST

### Patent Literature

[PTL 1]
JP 2016-203737A

### SUMMARY

### Technical Problem

However, PTL 1 does not take into consideration such a case where a user has returned to the inside of the transport from the place where the user stayed.

The present technology has been developed in consideration of such circumstances, and enables appropriate control of air conditioning, in a case where a user has moved into an air-conditioned space such as an interior of a vehicle, from a place where the user stayed.

### Solution to Problem

An air-conditioning control device according to one aspect of the present technology includes a parameter calculation unit that calculates an air-conditioning control parameter associated with control of an air-conditioning system, on the basis of stay information that includes a place of stay of a user before the user moves to a space where the air-conditioning system is provided.

An air-conditioning control method according to one aspect of the present technology is an air-conditioning control method including, by an air-conditioning control device, calculating an air-conditioning control parameter associated with control of an air-conditioning system, on the basis of stay information that includes a place of stay of a user before the user moves to a space where the air-conditioning system is provided.

A program according to one aspect of the present technology causes a computer to execute a process of calculating an air-conditioning control parameter associated with control of an air-conditioning system, on the basis of stay information that includes a place of stay of a user before the user moves to a space where the air-conditioning system is provided.

According to one aspect of the present technology, an air-conditioning control parameter associated with control of an air-conditioning system is calculated on the basis of stay information that includes a place of stay of a user before the user moves to a space where the air-conditioning system is provided.

### BRIEF DESCRIPTION OF DRAWINGS

FIG. 1 is a block diagram illustrating a configuration example of a vehicle control system.

FIG. 2 is a diagram illustrating an example of sensing regions.

FIG. 3 is a block diagram illustrating an air-conditioning control system according to an embodiment to which the present technology is applied.

FIG. 4 is a block diagram illustrating a configuration example of an air-conditioning processing system for a vehicle.

FIG. 5 is a block diagram illustrating a configuration example of a smartphone.

FIG. 6 is a block diagram illustrating a configuration example of a cloud system.

FIG. 7 is a flowchart for explaining a stay place adaptive air-conditioning control process executed by the vehicle.

FIG. 8 is a flowchart for explaining the stay place adaptive air-conditioning control process executed by the vehicle.

FIG. 9 is a flowchart for explaining a process executed by the smartphone according to the stay place adaptive air-conditioning control process performed by the vehicle and illustrated in FIGS. 7 and 8.

FIG. 10 is a flowchart for explaining a process executed by the cloud system according to the stay place adaptive air-conditioning control process performed by the vehicle and illustrated in FIGS. 7 and 8.

FIG. 11 is a block diagram illustrating a configuration example of a computer.

### DESCRIPTION OF EMBODIMENT

An embodiment according to the present technology will hereinafter be described in detail with reference to the drawings. Note that the description will be presented in the following order.
1. Configuration example of vehicle control system
2. Embodiment
3. Modifications
4. Others

### 1. Configuration Example of Vehicle Control System

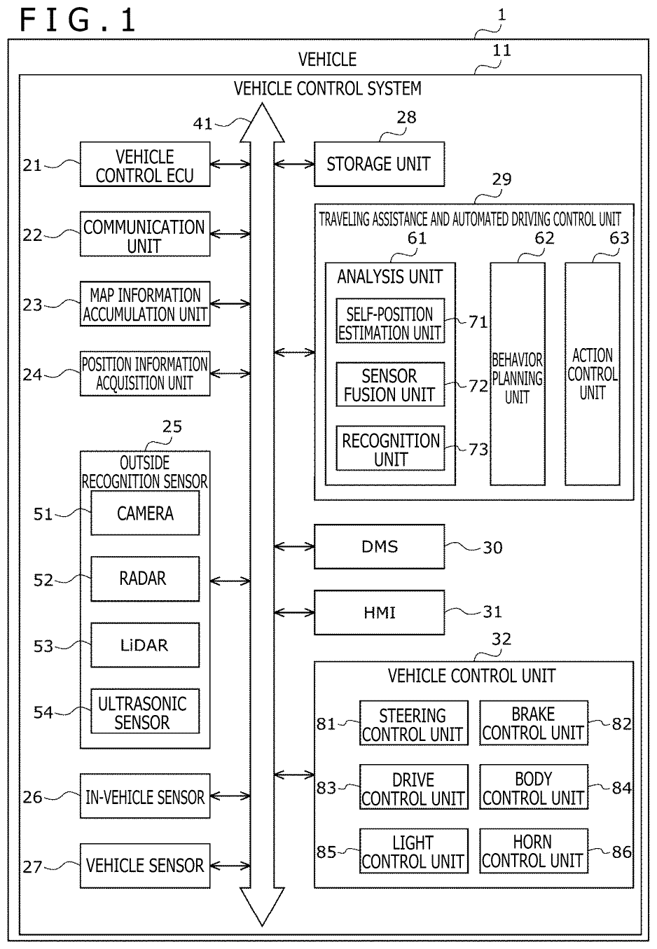

FIG. 1 is a block diagram illustrating a configuration example of a vehicle control system 11 that is an example of a moving device control system to which the present technology is applied.

The vehicle control system 11 is provided on a vehicle 1 to perform processes associated with traveling assistance and automated driving of the vehicle 1.

The vehicle control system 11 includes a vehicle control ECU (Electronic Control Unit) 21, a communication unit 22, a map information accumulation unit 23, a position information acquisition unit 24, an outside recognition sensor 25, an in-vehicle sensor 26, a vehicle sensor 27, a storage unit 28, a traveling assistance and automated driving control unit 29, a DMS (Driver Monitoring System) 30, an HMI (Human Machine Interface) 31, and a vehicle control unit 32.

The vehicle control ECU 21, the communication unit 22, the map information accumulation unit 23, the position information acquisition unit 24, the outside recognition sensor 25, the in-vehicle sensor 26, the vehicle sensor 27, the storage unit 28, the traveling assistance and automated driving control unit 29, the driver monitoring system (DMS) 30, the human machine interface (HMI) 31, and the vehicle control unit 32 are communicably connected to one another via a communication network 41. For example, the communication network 41 includes an on-vehicle communication network conforming to standards of digital bidirectional communication, such as a CAN (Controller Area Network), a LIN (Local Interconnect Network), a LAN (Local Area Network), FlexRay (registered trademark), and Ethernet (registered trademark), a bus, and the like. A different type of the communication network 41 may be used according to the type of data to be transferred. For example, a CAN may be adopted for data associated with vehicle control, while Ethernet may be adopted for a large volume of data. Note that the units of the vehicle control system 11 are directly connected to one another in some cases by using wireless communication handling relatively short distance communication, such as near field communication (NFC) and Bluetooth (registered trademark), without using the communication network 41.

In addition, it is assumed hereinafter that the communication network 41 will not be particularly mentioned even in cases where the units of the vehicle control system 11 communicate with one another via the communication network 41. For example, in a case where the vehicle control ECU 21 and the communication unit 22 communicate with each other via the communication network 41, this situation will be simply expressed that the vehicle control ECU 21 and the communication unit 22 communicate with each other.

For example, the vehicle control ECU 21 includes various types of processors, such as a CPU (Central Processing unit) and an MPU (Micro Processing Unit). The vehicle control ECU 21 controls the overall or some of functions of the vehicle control system 11.

The communication unit 22 communicates with various devices inside or outside the vehicle, other vehicles, servers, base stations, and the like to transmit and receive various types of data. In this case, the communication unit 22 is allowed to communicate by using multiple communication systems.

An outline of communication achievable between the communication unit 22 and the outside of the vehicle will be described upon. For example, the communication unit 22 communicates with a server or the like being present on an external network (hereinafter referred to as an external server) via a base station or an access point by using a wireless communication system such as 5G (fifth mobile communication system), LTE (Long Term Evolution), and DSRC (Dedicated Short Range Communications). For example, the external network available for achieving communication by the communication unit 22 is the Internet, a cloud network, a provider-specific network, or the like. The communication system adopted by the communication unit 22 for communication with the external network is not specifically restricted as long as the communication system is a wireless communication system capable of achieving digital bidirectional communication at least at a predetermined communication speed and at least at a predetermined distance.

Moreover, for example, the communication unit 22 is capable of communicating with a terminal present near a subject vehicle by using P2P (Peer To Peer) technology. For example, the terminal present near the subject vehicle is a terminal attached to a moving body moving at a relatively low speed, such as a pedestrian and a bicycle, a terminal provided at a fixed position of a store or the like, or an MTC (Machine Type Communication) terminal. Furthermore, the communication unit 22 is capable of achieving V2X communication. For example, V2X communication refers to communication between the subject vehicle and others, such as vehicle to vehicle (Vehicle to Vehicle) communication with another vehicle, vehicle to infrastructure (Vehicle to Infrastructure) communication with a roadside unit or the like, vehicle to home (Vehicle to Home) communication with home, and vehicle to pedestrian (Vehicle to Pedestrian) communication with a terminal or the like carried by a pedestrian.

For example, the communication unit 22 is capable of receiving, from the outside, a program for updating software which controls actions of the vehicle control system 11 (Over The Air). The communication unit 22 is further capable of receiving, from the outside, map information, traffic information, information associated with surroundings of the vehicle 1, and the like. Moreover, for example, the communication unit 22 is capable of transmitting information associated with the vehicle 1, information associated with surroundings of the vehicle 1, and the like to the outside. For example, the information associated with the vehicle 1 and transmitted to the outside from the communication unit 22 includes data indicating a state of the vehicle 1, a recognition result obtained by a recognition unit 73, and the like. Furthermore, for example, the communication unit 22 handles communications corresponding to a vehicle emergency report system, such as e-Call.

For example, the communication unit 22 receives radio waves transmitted from Vehicle Information and Communication System (VICS) (registered trademark), such as radio wave beacons, optical beacons, and FM multiplex broadcasting.

An outline of communication achievable by the communication unit 22 to communicate with the interior of the vehicle will be explained. For example, the communication unit 22 is capable of communicating with devices inside the vehicle by using wireless communication. For example, the communication unit 22 is capable of wirelessly communicating with the devices inside the vehicle by using a communication system achieving digital bidirectional communication at a predetermined communication speed or higher by wireless communication, such as a wireless LAN, Bluetooth, NFC, and WUSB (Wireless USB). Alternatively, the communication unit 22 is also capable of communicating with the devices inside the vehicle by using wired communication. For example, the communication unit 22 is capable of communicating with the devices inside the vehicle by wired communication using a cable connected to a not-illustrated connection terminal. For example, the communication unit 22 is capable of communicating with the devices inside the vehicle by using a communication system achieving digital bidirectional communication at a predetermined communication speed or higher by wired communication, such as USB (Universal Serial Bus), HDMI (High-Definition Multimedia Interface) (registered trademark), and MHL (Mobile High-definition Link).

For example, the devices inside the vehicle herein refer to devices provided inside the vehicle and not connected to the communication network 41. For example, the devices inside the vehicle may include a mobile device or a wearable device carried by an occupant of the vehicle such as a driver, an information device carried into the vehicle and temporarily installed, and the like.

The map information accumulation unit 23 accumulates either one of or both a map acquired from the outside and a map created by the vehicle 1. For example, the map information accumulation unit 23 accumulates a three-dimensional high-definition map, a global map which is less accurate than a high-definition map but covers a wide area, and others.

For example, the high-definition map is a dynamic map, a point cloud map, a vector map, or the like. For example, the dynamic map is a map including four layers, i.e., dynamic information, semi-dynamic information, semi-static information, and static information, and is provided for the vehicle 1 from an external server or the like. The point cloud map is a map including a point cloud (point cloud data). For example, the vector map is a map which correlates traffic information or the like, such as positions of lanes and traffic lights, with a point cloud map to fit with ADAS (Advanced Driver Assistance System) and AD (Autonomous Driving).

For example, the point cloud map and the vector map may be provided from an external server or the like, or may be created by the vehicle 1 on the basis of a sensing result obtained by a camera 51, a radar 52, LiDAR 53, or the like as a map for matching with a local map described below, and accumulated in the map information accumulation unit 23. Moreover, in a case where the high-definition map is provided from an external Server or the like, map data covering a several-hundred-meter square area, for example, and associated with a planned path along which the vehicle 1 is to travel is acquired from the external server or the like to reduce a communication volume.

The position information acquisition unit 24 receives GNSS (Global Navigation Satellite System) signals from a GNSS satellite to acquire position information associated with the vehicle 1. The acquired position information is supplied to the traveling assistance and automated driving control unit 29. Note that the method adopted by the position information acquisition unit 24 is not limited to the method using GNSS signals. For example, the position information may be acquired by using beacons.

The outside recognition sensor 25 includes various types of sensors for recognizing situations outside the vehicle 1, and supplies pieces of sensor data received from the respective sensors to the respective units of the vehicle control system 11. The types and the number of the sensors included in the outside recognition sensor 25 may be any type and any number.

For example, the outside recognition sensor 25 includes the camera 51, the radar 52, the LiDAR (Light Detection and Ranging, Laser Imaging Detection and Ranging) 53, and an ultrasonic sensor 54. In addition, the outside recognition sensor 25 may include one or more types of sensors selected from the camera 51, the radar 52, the LiDAR 53, and the ultrasonic sensor 54. The number of each of the camera 51, the radar 52, the LiDAR 53, and the ultrasonic sensor 54 is not limited to a specific number, and may be any number providable on the vehicle 1 in actual situations. Moreover, the types of the sensors included in the outside recognition sensor 25 are not limited to the examples presented above. The outside recognition sensor 25 may include other types of sensors. Examples of sensing regions of the sensors included in the outside recognition sensor 25 will be described below.

Note that the imaging method adopted by the camera 51 is not limited to a specific method. For example, any one of cameras using various types of distance-measurable imaging methods, such as a ToF (Time Of Flight) camera, a stereo camera, a monocular camera, and an infrared camera, may be applied to the camera 51 as necessary. In addition, the camera 51 may be a camera for simply capturing images rather than for measuring distances.

In addition, for example, the outside recognition sensor 25 may include an environment sensor for detecting an environment provided for the vehicle 1. The environment sensor is a sensor configured to detect an environment such as weather, meteorology, and brightness, and may include various types of sensors such as a raindrop sensor, a fog sensor, a sunlight sensor, a snow sensor, and an illuminance sensor, for example.

Furthermore, for example, the outside recognition sensor 25 includes a microphone for detecting sounds around the vehicle 1, positions of sound sources, and other purposes.

The in-vehicle sensor 26 includes various types of sensors for detecting information inside the vehicle, and supplies pieces of sensor data received from the respective sensors to the respective units of the vehicle control system 11. The type and the number of each of the various sensors included in the in-vehicle sensor 26 are not limited to a specific type and a specific number, and may be any type and any number providable on the vehicle 1 in actual situations.

For example, the in-vehicle sensor 26 may include one or more types of sensors selected from a camera, a radar, a seat sensor, a steering wheel sensor, a microphone, and a biosensor. For example, cameras using various types of distance-measurable imaging methods, such as a ToF camera, a stereo camera, a monocular camera, and an infrared camera, may be adopted as the camera included in the in-vehicle sensor 26. In addition, the camera included in the in-vehicle sensor 26 may be a camera for simply capturing images rather than for measuring distances. For example, the biosensor included in the in-vehicle sensor 26 is provided on a seat, a steering wheel, or the like to detect various types of biological information associated with the occupant of the vehicle, such as the driver.

The vehicle sensor 27 includes various sensors for detecting a state of the vehicle 1, and supplies pieces of sensor data received from the respective sensors to the respective units of the vehicle control system 11. The type and the number of each of the various sensors included in the vehicle sensor 27 are not limited to a specific type and a specific number, and may be any type and any number providable on the vehicle 1 in actual situations.

For example, the vehicle sensor 27 includes a speed sensor, an acceleration sensor, an angular velocity sensor (gyro sensor), and an inertial measurement device (IMU (Inertial Measurement Unit)) integrating these. For example, the vehicle sensor 27 includes a steering angle sensor for detecting a steering angle of a steering wheel, a yaw rate sensor, an accelerator sensor for detecting an operation amount of an accelerator pedal, and a brake sensor for detecting an operation amount of a brake pedal. For example, the vehicle sensor 27 includes a revolution sensor for detecting the number of revolutions of an engine or a motor, an air pressure sensor for detecting air pressure of tires, a slip ratio sensor for detecting a slip ratio of tires, and a wheel speed sensor for detecting a rotation speed of wheels. For example, the vehicle sensor 27 includes a battery sensor for detecting a residual quantity and a temperature of a battery, and a shock sensor for detecting a shock applied from the outside.

The storage unit 28 includes at least either a non-volatile storage medium or a volatile storage medium to store data and a program. For example, the storage unit 28 is provided as an EEPROM (Electrically Erasable Programmable Read Only Memory) and a RAM (Random Access Memory). As a storage medium, a magnetic storage device such as an HDD (Hard Disc Drive), a semiconductor storage device, an optical storage device, and a magneto-optical storage device are adoptable. The storage unit 28 stores various types of programs and data used by the units of the vehicle control system 11. For example, the storage unit 28 includes an EDR (Event Data Recorder) and a DSSAD (Data Storage System for Automated Driving) to store information associated with the vehicle 1 and information acquired by the in-vehicle sensor 26 before and after an event such as an accident.

The traveling assistance and automated driving control unit 29 controls traveling assistance and automated driving of the vehicle 1. For example, the traveling assistance and automated driving control unit 29 includes an analysis unit 61, a behavior planning unit 62, and an action control unit 63.

The analysis unit 61 performs an analysis process for analyzing situations of the vehicle 1 and surroundings. The analysis unit 61 includes a self-position estimation unit 71, a sensor fusion unit 72, and the recognition unit 73.

The self-position estimation unit 71 estimates a self-position of the vehicle 1 on the basis of sensor data received from the outside recognition sensor 25 and a high-definition map accumulated in the map information accumulation unit 23. For example, the self-position estimation unit 71 estimates the self-position of the vehicle 1 by creating a local map on the basis of sensor data received from the outside recognition sensor 25, and matching the local map with the high-definition map. For example, the position of the vehicle 1 is defined on the basis of a center of an axle of a pair of rear wheels.

For example, the local map is a three-dimensional high-definition map, an occupancy grid map (Occupancy Grid Map), or the like created using a technology such as SLAM (Simultaneous Localization and Mapping). For example, the three-dimensional high-definition map is a point cloud map or the like described above. The occupancy grid map is a map indicating an occupancy state of an object with a unit of a grid formed by dividing a three-dimensional or two-dimensional space around the vehicle 1 and having a predetermined size. For example, the occupancy state of the object is indicated by presence or absence of the object or a probability of presence. For example, the local map is also employed for a detection process and a recognition process performed by the recognition unit 73 for detecting and recognizing an outside situation of the vehicle 1.

Note that the self-position estimation unit 71 may estimate the self-position of the vehicle 1 on the basis of position information acquired by the position information acquisition unit 24, and sensor data received from the vehicle sensor 27.

The sensor fusion unit 72 performs a sensor fusion process for obtaining new information by combining multiple different types of sensor data (e.g., image data supplied from the camera 51, and sensor data supplied from the radar 52). Methods such as integration, fusion, and unification are available for combining the different types of sensor data.

The recognition unit 73 executes a detection process for detecting a situation outside the vehicle 1, and a recognition process for recognizing a situation outside the vehicle 1.

For example, the recognition unit 73 performs the detection process and the recognition process associated with a situation outside the vehicle 1 on the basis of information received from the outside recognition sensor 25, information received from the self-position estimation unit 71, information received from the sensor fusion unit 72, and the like.

Specifically, for example, the recognition unit 73 performs a detection process, a recognition process, and the like associated with an object around the vehicle 1. For example, the detection process associated with the object is a process for detecting presence or absence, a size, a shape, a position, a movement, or the like of the object. For example, the recognition process associated with the object is a process for recognizing an attribute of the type or the like of the object, or for identifying a specific object. Note that the detection process and the recognition process are not necessarily distinguishable clearly from each other. These processes overlap with each other in some cases.

For example, the recognition unit 73 detects the object around the vehicle 1 on the basis of clustering to classify point clouds, which are produced on the basis of sensor data obtained by the radar 52, the LiDAR 53, or the like, into masses of point clouds. In this manner, the presence or absence, the size, the shape, and the position of the object around the vehicle 1 are detected.

For example, the recognition unit 73 detects the movement of the object around the vehicle 1 by tracking which follows a movement of a mass of point clouds classified by clustering. In this manner, a speed and an advancing direction (movement vector) of the object around the vehicle 1 are detected.

For example, the recognition unit 73 detects or recognizes vehicles, humans, bicycles, obstacles, structures, roads, traffic lights, traffic signs, road signs, and the like on the basis of image data supplied from the camera 51. Moreover, the recognition unit 73 may recognize the type of the object around the vehicle 1 by performing a recognition process such as semantic segmentation.

For example, the recognition unit 73 may perform a recognition process for recognizing traffic rules around the vehicle 1 on the basis of a map accumulated in the map information accumulation unit 23, an estimation result of the self-position obtained by the self-position estimation unit 71, and a recognition result of an object around the vehicle 1 obtained by the recognition unit 73. On the basis of this process, the recognition unit 73 can recognize positions and states of traffic lights, details of traffic signs and road signs, details of traffic rules, lanes available for traveling, and the like.

For example, the recognition unit 73 may perform a recognition process for recognizing an environment around the vehicle 1. The surrounding environment assumed as a recognition target for the recognition unit 73 includes weather, temperature, humidity, brightness, road surface conditions, and the like.

The behavior planning unit 62 creates a behavior plan of the vehicle 1. For example, the behavior planning unit 62 creates the behavior plan by performing processes for global path planning and path following.

Note that the global path planning is a process for planning a rough path from a start to a goal. This global path planning includes a process called local path planning, and creating a local path located near the vehicle 1 and allowing safe and smooth traveling in the planned global path in consideration of motility characteristics of the vehicle 1.

The path following is a process for planning an action required for achieving safe and accurate traveling along the path planned by the global path planning within a planned time. For example, the behavior planning unit 62 is capable of calculating a target speed and a target angular velocity of the vehicle 1 on the basis of a result of this process for the path following.

The action control unit 63 controls actions of the vehicle 1 to achieve a behavior plan created by the behavior planning unit 62.

For example, the action control unit 63 controls a steering control unit 81, a brake control unit 82, and a drive control unit 83 included in the vehicle control unit 32 described below to achieve acceleration and deceleration control and direction control such that the vehicle 1 can travel along a local path calculated by the local path planning. For example, the action control unit 63 performs cooperative control for achieving functions of ADAS, such as collision avoidance or shock mitigation, following traveling, vehicle-speed maintaining traveling, warning of collision by the subject vehicle, and warning of lane departure by the subject vehicle. For example, the action control unit 63 performs cooperative control for automated driving which achieves automated traveling without a necessity of operation by the driver, or for other purposes.

The DMS 30 performs an authentication process for authenticating the driver, a recognition process for recognizing a state of the driver, and the like on the basis of sensor data received from the in-vehicle sensor 26, input data input to the HMI 31 described below, and the like. For example, the state of the driver assumed as a recognition target includes a physical condition, a wakefulness level, a concentration level, a fatigue level, a visual line direction, a drunkenness level, a driving operation, a posture, and the like.

Note that the DMS 30 may perform an authentication process for authenticating an occupant other than the driver, and a recognition process for recognizing a state of this occupant. Moreover, for example, the DMS 30 may perform a recognition process for recognizing a situation inside the vehicle on the basis of sensor data received from the in-vehicle sensor 26. For example, the situation inside the vehicle assumed as a recognition target includes temperature, humidity, brightness, a smell, and the like.

The HMI 31 receives input of various types of data, instructions, and the like, and presents various types of data to the driver or the like.

An outline of data input performed by the HMI 31 will be described. The HMI 31 includes an input device provided for manual data input. The HMI 31 generates input signals on the basis of data, instructions, or the like input through the input device, and supplies the generated input signals to the respective units of the vehicle control system 11. For example, the HMI 31 includes an operating element such as a touch panel, a button, a switch, and a lever as the input device. In addition to this operation element, the HMI 31 may further include an input device capable of receiving input of information by a method other than a manual operation, such as voices and gestures. Furthermore, for example, the HMI 31 may include, as the input device, a remote control device using infrared light or radio waves, or an external connection device compatible with an operation of the vehicle control system 11, such as a mobile device and a wearable device.

An outline of data presentation achieved by the HMI 31 will be described. The HMI 31 generates visual information, auditory information, and tactile information provided for the occupant or the outside of the vehicle. Moreover, the HMI 31 performs output control for controlling output of the generated respective pieces of information, details of output, output timing, an output method, and the like. For example, as the visual information, the HMI 31 generates and outputs information indicated with images or light, such as an operation screen, state display of the vehicle 1, warning display, and a monitoring image representing situations around the vehicle 1. Moreover, for example, as the auditory information, the HMI 31 generates and outputs information indicated with sounds, such as voice guidance, warning sounds, and warning messages. Furthermore, for example, as the tactile information, the HMI 31 generates and outputs information given to the tactile sense of the occupant by using force, vibration, movement, or the like.

For example, the HMI 31 may include, as an output device for outputting the visual information, a display device which presents the visual information by displaying images on this display device, or a projector device which presents the visual information by projecting images. Note that the display device may be a device which displays the visual information within a visual field of the occupant, such as a head-up display, a transmissive display, and a wearable device having an AR (Augmented Reality) function, as well as the display device having an ordinary display. Moreover, the HMI 31 may employ, as the output device for outputting the visual information, a display device equipped on a navigation device, an instrument panel, a CMS (Camera Monitoring System), an electronic mirror, a lamp, or the like provided on the vehicle 1.

For example, the HMI 31 may include an audio speaker, a headphone, or an earphone as an output device for outputting the auditory information.

For example, the HMI 31 may include a haptics element using a haptics technology as an output device for outputting the tactile information. The haptics element is provided at a portion in contact with the occupant of the vehicle 1, such as a steering wheel and a seat.

The vehicle control unit 32 controls the units of the vehicle 1. The vehicle control unit 32 includes the steering control unit 81, the brake control unit 82, the drive control unit 83, a body control unit 84, a light control unit 85, and a horn control unit 86.

The steering control unit 81 performs detection, control, and the like associated with a state of a steering system of the vehicle 1. For example, the steering system includes a steering mechanism having a steering wheel and the like, an electronic power assisted steering, and others. For example, the steering control unit 81 includes a steering ECU for controlling the steering system, an actuator for driving the steering system, and others.

The brake control unit 82 performs detection, control, and the like associated with a state of a brake system of the vehicle 1. For example, the brake system includes a brake mechanism having a brake pedal and the like, an ABS (Antilock Brake System), a regenerative brake mechanism, and others. For example, the brake control unit 82 includes a brake ECU for controlling the brake system, an actuator for driving the brake system, and others.

The drive control unit 83 performs detection, control, and the like associated with a state of a drive system of the vehicle 1. For example, the drive system includes a driving force generation device for generating driving force for an accelerator pedal, an internal combustion engine, a driving motor, or the like, a driving force transmission mechanism for transmitting driving force to wheels, and others. For example, the drive control unit 83 includes a drive ECU for controlling the drive system, an actuator for driving the drive system, and others.

The body control unit 84 performs detection, control, and the like associated with a state of a body system of the vehicle 1. For example, the body system includes a keyless entry system, a smart key system, an automatic window device, power seats, an air-conditioning device, airbags, seatbelts, a gear shift, and others. For example, the body control unit 84 includes a body ECU for controlling the body system, an actuator for driving the body system, and others.

The light control unit 85 performs detection, control, and the like associated with states of various types of lights of the vehicle 1. For example, the lights assumed as control targets include headlights, backlights, fog lights, turn signals, brake lights, a projection, a bumper indication, and others. The light control unit 85 includes a light ECU for controlling lights, an actuator for driving lights, and others.

The horn control unit 86 performs detection, control, and the like associated with a state of a car horn of the vehicle 1. For example, the horn control unit 86 includes a horn ECU for controlling the car horn, an actuator for driving the car horn, and others.

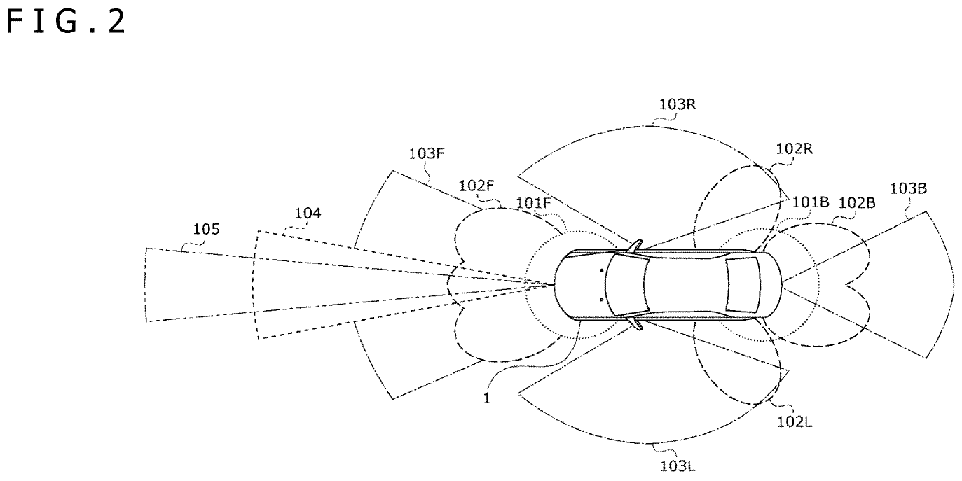

FIG. 2 is a diagram illustrating an example of sensing regions provided by the camera 51, the radar 52, the LiDAR 53, the ultrasonic sensor 54, and the like of the outside recognition sensor 25 in FIG. 1. Note that FIG. 2 schematically illustrates a state of the vehicle 1 viewed from the top. The left end side corresponds to the front end (front) side of the vehicle 1, while the right end side corresponds to the rear end (rear) side of the vehicle 1.

A sensing region 101F and a sensing region 101B represent examples of sensing regions of the ultrasonic sensor 54. The sensing region 101F covers an area around the front end of the vehicle 1 by using multiple sensors of the ultrasonic sensor 54. The sensing region 101B covers an area around the rear end of the vehicle 1 by using multiple sensors of the ultrasonic sensor 54.

For example, sensing results obtained in the sensing region 101F and the sensing region 101B are utilized for parking assistance or the like of the vehicle 1.

Sensing regions 102F to 102B represent examples of sensing regions of the radar 52 for short distances or middle distances. The sensing region 102F covers an area including farther locations than the sensing region 101F in front of the vehicle 1. The sensing region 102B covers an area including farther locations than the sensing region 101B at the rear of the vehicle 1. The sensing region 102L covers an area around the rear of the left side of the vehicle 1. The sensing region 102R covers an area around the rear of the right side of the vehicle 1.

For example, sensing results obtained in the sensing region 102F are utilized for detection or the like of a vehicle, a pedestrian, or the like present before the vehicle 1. For example, sensing results obtained in the sensing region 102B are utilized for a collision prevention function or the like behind the vehicle 1. For example, sensing results obtained in the sensing region 102L and the sensing region 102R are utilized for detection of an object located at a blind spot on the side of the vehicle 1, or the like.

Sensing regions 103F to 103B represent examples of sensing regions provided by the camera 51. The sensing region 103F covers an area including farther locations than the sensing region 102 in front of the vehicle 1F. The sensing region 103B covers an area including farther locations than the sensing region 102B at the rear of the vehicle 1. The sensing region 103L covers an area around the left side of the vehicle 1. The sensing region 103R covers an area around the right side of the vehicle 1.

For example, sensing results obtained in the sensing region 103F can be utilized for recognition of traffic lights and traffic signs, a lane departure prevention support system, and an automatic headlight control system. For example, sensing results obtained in the sensing region 103B can be utilized for parking assistance and a surround view system. For example, sensing results obtained in the sensing region 103L and the sensing region 103R are used for a surround view system.

A sensing region 104 represents an example of a sensing region of the LiDAR 53. The sensing region 104 covers an area including farther locations than the sensing region 103F in front of the vehicle 1. Meanwhile, a range of the sensing region 104 in the left-right direction is narrower than that range of the sensing region 103F.

For example, sensing results obtained in the sensing region 104 are utilized for detection of an object such as a surrounding vehicle.

A sensing region 105 represents an example of a sensing region of the radar 52 for long distances. The sensing region 105 covers an area including farther locations than the sensing region 104 in front of the vehicle 1. Meanwhile, a range of the sensing region 105 in the left-right direction is narrower than that range of the sensing region 104.

For example, sensing results obtained in the sensing region 105 are utilized for ACC (Adaptive Cruise Control), emergency braking, collision avoidance, or the like.

Note that the sensing regions of the respective sensors of the camera 51, the radar 52, the LiDAR 53, and the ultrasonic sensor 54 included in the outside recognition sensor 25 may have various configurations different from the regions illustrated in FIG. 2. Specifically, the ultrasonic sensor 54 may also sense the side of the vehicle 1, or the LiDAR 53 may sense the rear of the vehicle 1. Moreover, the installation positions of the respective sensors are not limited to the examples described above. Furthermore, the number of each of the sensors may be either one or more than one.

### 2. Embodiment

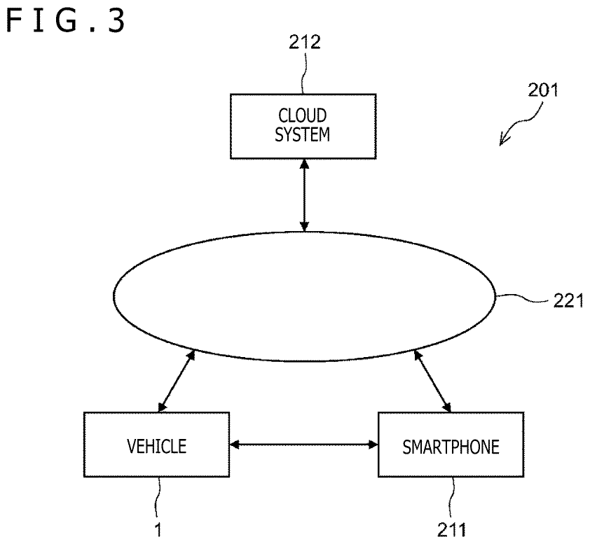

An embodiment according to the present technology will be subsequently described with reference to FIGS. 3 to 10.

### Configuration Example of Air-Conditioning Control System 201

FIG. 3 illustrates a configuration example of an air-conditioning control system 201 to which the present technology is applied.

The air-conditioning control system 201 includes the vehicle 1, a smartphone 211, and a cloud system 212. The vehicle 1, the smartphone 211, and the cloud system 212 are connected to each other via a network 221, such as the Internet, to be enabled to communicate with each other. Alternatively, the vehicle 1 and the smartphone 211 may be connected to each other without using the network 221.

For example, the cloud system 212 includes one or more servers, one or more databases, and others.

Note that the air-conditioning system 201 includes vehicles and smartphones of multiple users in actual situations. However, FIG. 3 illustrates only the one vehicle 1 and the one smartphone 211 for simplifying the following description.

The air-conditioning control system 201 is a system which executes control of the air-conditioning system of the vehicle 1 on the basis of a place of stay, a time of stay, or the like of a user carrying the smartphone 211.

For example, the vehicle 1 requests the smartphone 211 to collect stay information including the place of stay, the time of stay, and the like of the user.

The smartphone 211 is employed to set a destination, a path, and an air-conditioning mode of the vehicle 1. Moreover, the smartphone 211 collects stay information associated with the user, and transmits the stay information to the vehicle 1 in response to the request from the vehicle 1.

In response to this transmission, the vehicle 1 transmits the stay information associated with the user to the cloud system 212 via the network 221, and requests an air-conditioning parameter associated with control of the air-conditioning system of the vehicle 1.

In response to this request, the cloud system 212 calculates an air-conditioning control parameter by using an air-conditioning control model on the basis of the stay information associated with the user and received from the vehicle 1.

For example, the air-conditioning control model is a model which calculates an air-conditioning control parameter on the basis of stay information associated with the user. For example, the air-conditioning control model is created for each user (personalized), and reflects preferences, characteristics, and the like of each user. For example, the preferences of the user include a temperature or the like favored (felt comfortable) by the user, and others. For example, the characteristics of the user include characteristics associated with a body temperature of the user. For example, the characteristics associated with the body temperature of the user include a normal temperature of the user, a correlation between an ambient temperature and the body temperature, and the like.

The cloud system 212 transmits a calculated air-conditioning control parameter to the vehicle 1 via the network 221.

Meanwhile, the vehicle 1 controls the air-conditioning system on the basis of the received air-conditioning control parameter. Moreover, in a case where a setting of the air-conditioning system is input by the user under control of the air-conditioning system on the basis of the air-conditioning control parameter, the vehicle 1 transmits information indicating setting details of the air-conditioning system to the cloud system 212 via the network 221.

In response to this transmission, the cloud system 212 updates the air-conditioning control model of the corresponding user on the basis of the setting details of the air-conditioning system input by the user.

### Configuration Example of Air-Conditioning Control System 301

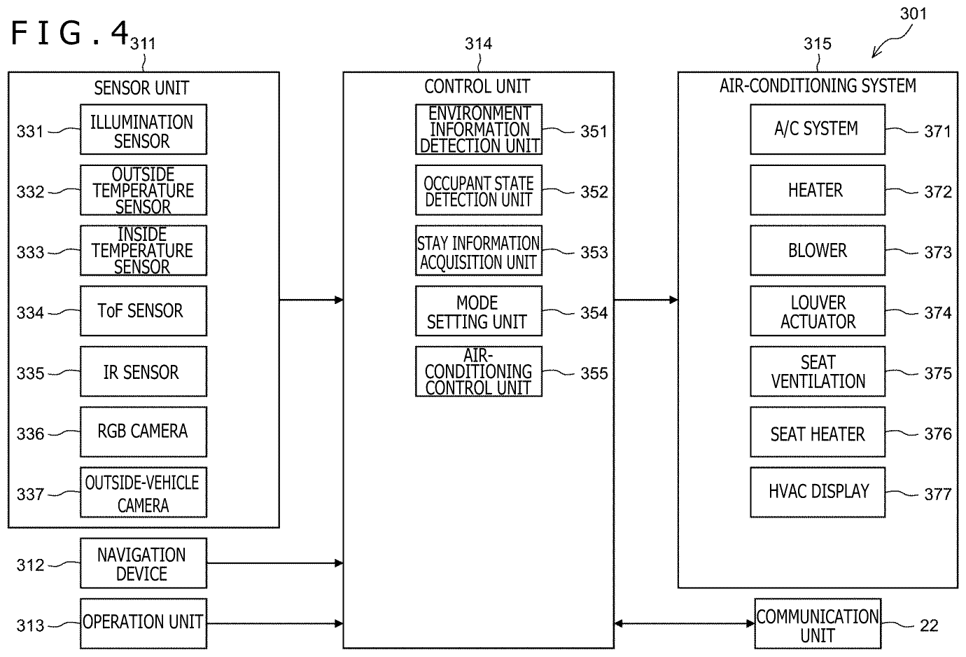

FIG. 4 illustrates a configuration example of an air-conditioning processing system 301 provided on the vehicle 1.

The air-conditioning processing system 301 executes processing associated with air conditioning for the vehicle 1. The air-conditioning processing system 301 includes the communication unit 22, a sensor unit 311, a navigation device 312, an operation unit 313, a control unit 314, and an air-conditioning system 315.

The sensor unit 311 includes an illuminance sensor 331, an outside temperature sensor 332, an inside temperature sensor 333, a ToF sensor 334, an IR sensor 335, an RGB camera 336, and an outside-vehicle camera 337.

For example, an illuminance sensor 331 constitutes the outside recognition sensor 25 in FIG. 1. The illuminance sensor 331 detects illuminance of sunlight or the like around the vehicle 1. The illuminance sensor 331 supplies sensor data indicating a detection result (hereinafter referred to as illuminance data) to the control unit 314.

For example, the outside temperature sensor 332 constitutes the outside recognition sensor 25 in FIG. 1. The outside temperature sensor 332 detects a temperature (outside temperature) around the vehicle 1. The outside temperature sensor 332 supplies sensor data indicating a detection result (hereinafter referred to as outside temperature data) to the control unit 314.

For example, the inside temperature sensor 333 constitutes the in-vehicle sensor 26 in FIG. 1. The inside temperature sensor 333 detects a temperature (inside temperature) inside the vehicle 1. The inside temperature sensor 333 supplies sensor data indicating a detection result (hereinafter referred to as inside temperature data) to the control unit 314.

For example, the ToF sensor 334 constitutes the in-vehicle sensor 26 in FIG. 1. The ToF sensor 334 captures an image of an occupant inside the vehicle 1. The ToF sensor 334 supplies depth image data obtained by imaging (hereinafter referred to as occupant depth image data) to the control unit 314.

For example, the IR sensor 335 constitutes the in-vehicle sensor 26 in FIG. 1. The IR sensor 335 detects a body temperature of the occupant inside the vehicle 1. The IR sensor 335 supplies sensor data indicating a detection result (hereinafter referred to as body temperature data) to the control unit 314.

For example, the RGB camera 336 constitutes the in-vehicle sensor 26 in FIG. 1. The RGB camera 336 captures an image of the occupant inside the vehicle 1. The RGB camera 336 supplies image data obtained by imaging (hereinafter referred to as occupant image data) to the control unit 314.

For example, the outside-vehicle camera 337 constitutes the camera 51 in FIG. 1. The outside-vehicle camera 337 captures an image around the vehicle 1. The outside-vehicle camera 337 supplies image data obtained by imaging (hereinafter referred to as surrounding image data) to the control unit 314.

For example, the navigation device 312 constitutes the HMI 31 in FIG. 1. For example, the navigation device 312 supplies information indicating a destination, a path, and the like set by the user to the control unit 314.

For example, the operation unit 313 includes various types of operation devices, and constitutes the HMI 31 in FIG. 1. The operation unit 313 is employed for operating the air-conditioning system 315, and supplies operation signals indicating operation details to the control unit 314.

For example, the control unit 314 is implemented by a body domain controller of the vehicle 1, and executes various types of processes and control for the units of the air-conditioning processing system 301. The air-conditioning processing system 301 includes an environment information detection unit 351, an occupant state detection unit 352, a stay information acquisition unit 353, a mode setting unit 354, and an air-conditioning control unit 355.

The environment information detection unit 351 detects information associated with ambient and internal environments of the vehicle 1. For example, the environment information detection unit 351 detects illuminance around the vehicle 1 on the basis of illuminance data. For example, the environment information detection unit 351 detects an outside temperature on the basis of outside temperature data. For example, the environment information detection unit 351 detects an inside temperature on the basis of inside temperature data.

The occupant state detection unit 352 detects a state of an occupant. For example, the occupant state detection unit 352 detects a posture of the occupant on the basis of occupant depth image data. For example, the occupant state detection unit 352 detects a body temperature of the occupant on the basis of body temperature data. For example, the occupant state detection unit 352 detects an external appearance (e.g., physique, clothing) of the occupant on the basis of occupant image data.

The stay information acquisition unit 353 acquires stay information associated with a place of stay or the like of the user. For example, the stay information acquisition unit 353 acquires from the navigation device 312 information associated with a destination where the user is scheduled to stay. For example, the stay information acquisition unit 353 acquires information associated with a place of stay of the user around the vehicle 1, for example, on the basis of surrounding image data. The stay information acquisition unit 353 receives stay information associated with the user from the smartphone 211 via the communication unit 22.

The mode setting unit 354 sets an air-conditioning mode of the vehicle 1 on the basis of an operation by the user, ambient and internal environments of the vehicle 1, a state of the vehicle 1, a state of the occupant, and others.

The air-conditioning control unit 355 controls the air-conditioning system 315 on the basis of an operation by the user, ambient and internal environments of the vehicle 1, a state of the vehicle 1, a state of the occupant, and others.

Moreover, in a case where the air-conditioning mode is set to a stay place adaptive mode described below, the air-conditioning control unit 355 transmits stay information associated with the user to the cloud system 212 via the communication unit 22 and the network 221, and receives from the cloud system 212 an air-conditioning control parameter based on the stay information associated with the user. The air-conditioning control unit 355 controls the air-conditioning system 315 on the basis of the received air-conditioning control parameter. Furthermore, in a case where the user inputs a setting to the air-conditioning system 315 under a situation where the air-conditioning system 315 is controlled according to the air-conditioning control parameter, the air-conditioning control unit 355 transmits information indicating setting details to the cloud system 212 via the communication unit 22 and the network 221.

The air-conditioning system 315 includes an A/C (Air Conditioner) system 371, a heater 372, a blower 373, a louver actuator 374, a seat ventilation 375, a seat heater 376, and an HVAC (Heating, Ventilation, and Air Conditioning) display 377.

The A/C system 371 is a heating and cooling system which cools or heats the interior of the vehicle.

The heater 372 is a heater for heating the interior of the vehicle.

The blower 373 is a blower for supplying air to the interior of the vehicle.

The louver actuator 374 is a device for controlling an air direction inside the vehicle.

The seat ventilation 375 is a device which supplies and sucks air from and into a seat to cool the body of the occupant sitting on this seat.

The seat heater 376 is a device for warming a seat.

The HVAC display 377 is a device for displaying a setting value, a state, and the like of the air-conditioning system 315.

### Configuration Example of Functions of Smartphone 211

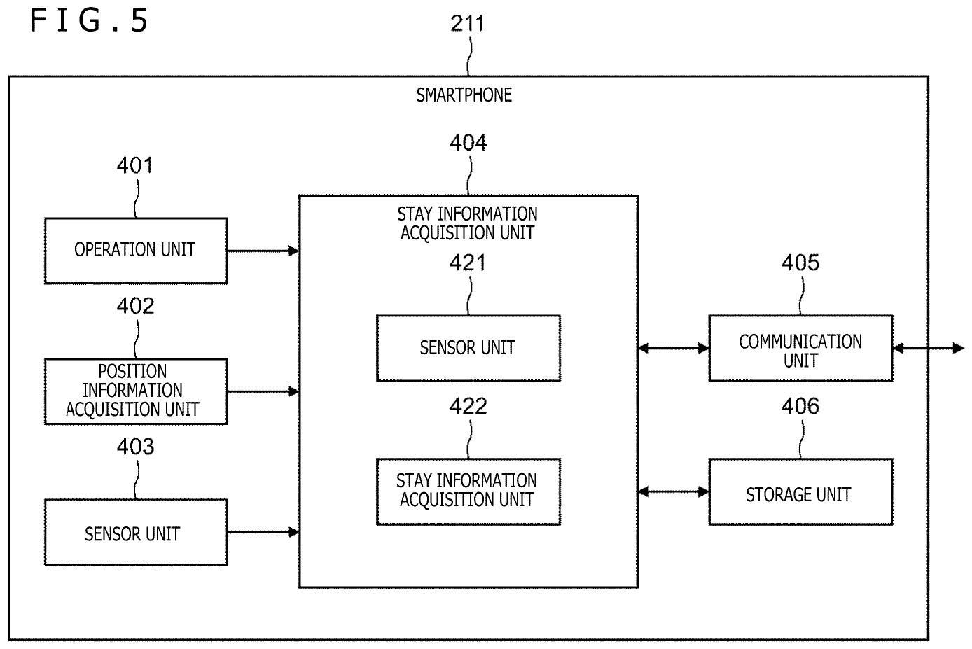

FIG. 5 illustrates a configuration example of functions performed by the smartphone 211 and associated with a part executing processing for controlling the air-conditioning system 315 of the vehicle 1.

The smartphone 211 includes an operation unit 401, a position information acquisition unit 402, a sensor unit 403, an on-vehicle air-conditioning control unit 404, a communication unit 405, and a storage unit 406.

For example, the operation unit 401 includes various types of operation devices, and is employed to operate the smartphone 211 and supply operation signals indicating operation details to the on-vehicle air-conditioning control unit 404.

For example, the position information acquisition unit 402 receives GNSS signals from a GNSS satellite to acquire position information of the smartphone 211. The position information acquisition unit 402 supplies the acquired position information to the on-vehicle air-conditioning control unit 404.

For example, the sensor unit 403 includes various types of sensors such as a camera and an IMU (Inertial Measurement Unit). The sensor unit 403 supplies sensor data indicating detection results obtained by the sensors to the on-vehicle air-conditioning control unit 404.

For example, the on-vehicle air-conditioning control unit 404 is implemented by predetermined application software (hereinafter referred to as on-vehicle air-conditioning control APP) executed by a processor such as a CPU. The on-vehicle air-conditioning control unit 404 includes a setting unit 421 and a stay information acquisition unit 422.

The setting unit 421 determines settings associated with the air-conditioning system 315 of the vehicle 1 according to an operation performed by the user for the operation unit 401. For example, the setting unit 421 determines such settings as a destination, a path, and an air-conditioning mode of the vehicle 1, and transmits information indicating setting details to the vehicle 1 via the communication unit 405.

The stay information acquisition unit 422 receives a request for collecting stay information associated with the user from the vehicle 1 via the communication unit 405. In response to this request, for example, the stay information acquisition unit 422 acquires information associated with a place of stay, a location of stay, and the like associated with the user on the basis of position information received from the position information acquisition unit 402, and sensor data received from the sensor unit 403, and causes the storage unit 406 to store the acquired information. Thereafter, the stay information acquisition unit 422 generates stay information associated with the user on the basis of the information stored in the storage unit 406, and transmits the generated stay information to the vehicle 1 via the communication unit 405.

The communication unit 405 communicates with the vehicle 1, the cloud system, and others via the network 221. Moreover, the communication unit 405 communicates with the vehicle 1 by near field communication or the like without using the network 221.

The storage unit 406 stores information necessary for processing performed by the smartphone 211.

### Configuration Example of Cloud System 212

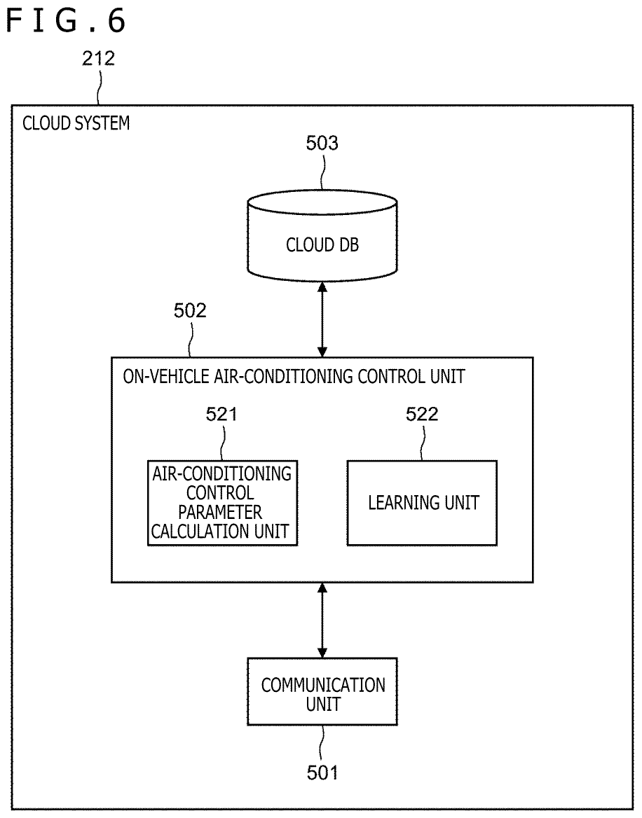

FIG. 6 illustrates a configuration example of functions of the cloud system 212. The cloud system 212 includes a communication unit 501, an on-vehicle air-conditioning control unit 502, and a cloud DB (database) 503.

The communication unit 501 communicates with the vehicle 1, the smartphone 211, and others via the network 221.

The on-vehicle air-conditioning control unit 502 executes remote control of the air-conditioning system 315 of the vehicle 1. The on-vehicle air-conditioning control unit 502 includes an air-conditioning control parameter calculation unit 521 and a learning unit 522.

The air-conditioning control parameter calculation unit 521 receives stay information associated with the user from the vehicle 1 via the network 221 and the communication unit 501, and accumulates the received stay information in the cloud DB 503. The air-conditioning control parameter calculation unit 521 calculates an air-conditioning control parameter associated with control of the air-conditioning system 315 of the vehicle 1 on the basis of the stay information associated with the user, and air-conditioning control models provided for each user and accumulated in the cloud DB 503. The air-conditioning control parameter calculation unit 521 transmits the air-conditioning control parameter to the vehicle 1 via the communication unit 501 and the network 221.

In a case where information indicating setting details associated with the air-conditioning system and input by the user is received from the vehicle 1 via the network 221 and the communication unit 501, the learning unit 522 relearns the air-conditioning control model for the corresponding user on the basis of the setting details input by the user, to update a parameter of the air-conditioning control model. The learning unit 522 accumulates the updated air-conditioning control model in the cloud DB 503.

The cloud DB 503 accumulates stay information and air-conditioning control models associated with respective users.

### Stay Place Adaptive On-Vehicle Air-Conditioning Control Process

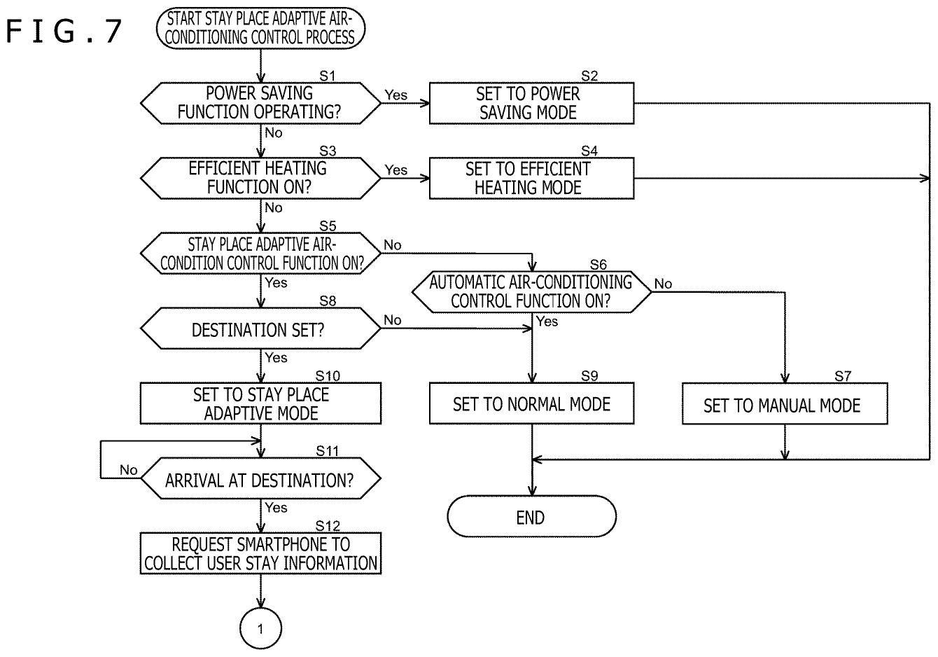

A process executed by the air-conditioning control system 201 will subsequently be described with reference to FIGS. 7 to 10.

### Stay Place Adaptive Air-Conditioning Control Process

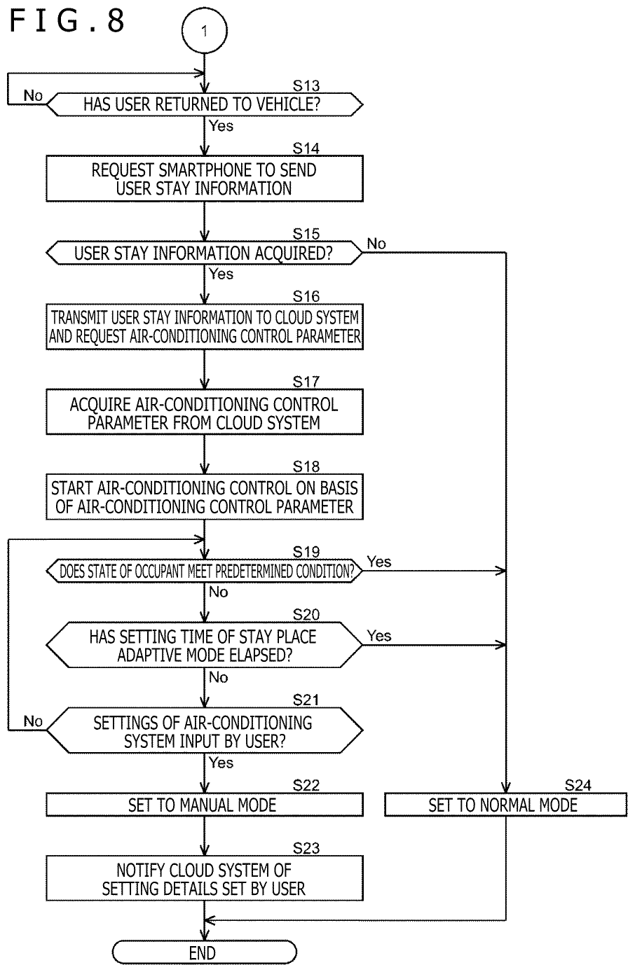

A stay place adaptive air-conditioning control process executed by the vehicle 1 will initially be described with reference to flowcharts in FIGS. 7 and 8.

For example, this process is started when the vehicle 1 is powered on at a place of departure of the vehicle 1.

In step S1, the mode setting unit 354 determines whether or not a power saving function is operating. In a case of determination that the power saving function is operating, the process proceeds to step S2.

The power saving function is a function for reducing power consumption of the vehicle 1. For example, the power saving function operates in a case where a residual quantity of the battery of the vehicle 1 is smaller than a predetermined threshold, a case where the residual quantity of the battery is not sufficient for global path planning of the vehicle 1, or other cases.

In step S2, the mode setting unit 354 sets the air-conditioning mode of the vehicle 1 to a power saving mode.

In the power saving mode, for example, a temperature set during cooling is slightly higher, and a temperature set during heating is slightly lower in comparison with those temperatures of a normal mode described below.

Thereafter, the stay place adaptive air-conditioning control process ends. Specifically, in a case where the power saving function is operating, the power saving function is designated as a preferential function, and a stay place adaptive air-conditioning control function is not executed.

Meanwhile, in a case of determination that the power saving function is not operating in step S1, the process proceeds to step S3.

In step S3, the mode setting unit 354 determines whether or not an efficient heating function has been turned on. In a case of determination that the efficient heating function has been turned on, the process proceeds to step S4.

In step S4, the mode setting unit 354 sets the air-conditioning mode of the vehicle 1 to an efficient heating mode.

In the efficient heating mode, for example, heating is efficiently executed by use of a heat pump or the like. Note that operation during cooling is performed in a manner similar to the manner of operation in the normal mode, for example.

Thereafter, the stay place adaptive air-conditioning control process ends. Specifically, in the case where the efficient heating function has been turned on, the efficient heating function is designated as a preferential function, and the stay place adaptive air-conditioning control function is not executed.

Meanwhile, in a case of determination that the efficient heating function has been turned off in step S3, the process proceeds to step S5.

In step S5, the mode setting unit 354 determines whether or not the stay place adaptive air-conditioning control function has been turned on. In a case of determination that the stay place adaptive air-conditioning control function has been turned off, the process proceeds to step S6.

In step S6, the mode setting unit 354 determines whether or not an automatic air-conditioning control function has been turned on. In a case of determination that the automatic air-conditioning control function has been turned off, the process proceeds to step S7.

In step S7, the mode setting unit 354 sets the air-conditioning mode of the vehicle 1 to a manual mode.

In the manual mode, the air-conditioning system 315 operates on the basis of a setting value set by the user, for example.

Thereafter, the stay place adaptive air-conditioning control process ends.

Meanwhile, in a case of determination that the automatic air-conditioning control function has been turned on in step S6, the process proceeds to step S9.

In addition, in a case of determination that the stay place adaptive air-conditioning control function has been turned on in step S5, the process proceeds to step S8.

In step S8, the mode setting unit 354 determines whether or not a destination has been set. In a case of determination that no destination has been set, the process proceeds to step S9.

In step S9, the mode setting unit 354 sets the air-conditioning mode of the vehicle 1 to the normal mode. Specifically, in a case where the stay place adaptive air-conditioning control function has been turned off, or a case where no destination has been set even in the on-state of the stay place adaptive air-conditioning control function, the air-conditioning mode of the vehicle 1 is set to the normal mode.

In the normal mode, the air-conditioning system 315 is automatically controlled on the basis of ambient and inside environments of the vehicle 1, a state of the occupant, and others. For example, outputs of the respective devices of the air-conditioning system 315 are controlled on the basis of a body temperature of the occupant, an inside temperature, and an outside temperature to control a temperature, an air volume, an air direction, and the like of the air-conditioning system 315. For example, air distribution of the air-conditioning system 315 is controlled on the basis of a posture, a clothing state, or the like of the occupant such that heat exchange from a body surface of the occupant can uniformly be achieved.

Thereafter, the stay place adaptive air-conditioning control process ends.

Meanwhile, in a case where the mode setting unit 354 acquires information indicating a destination of the vehicle 1 set by the user with use of the navigation device 312 or the smartphone 211 in step S8, for example, it is determined that the destination has been set, and the process proceeds to step S10.

In step S10, the mode setting unit 354 sets the air-conditioning mode of the vehicle 1 to a stay place adaptive mode.

Note that the air-conditioning control unit 355 executes air-conditioning control in a manner similar to the manner of air-conditioning control in the normal mode set as the air-conditioning mode until an arrival at the destination, for example.

In step S11, the stay information acquisition unit 353 determines whether or not an arrival at the destination has been completed on the basis of information received from the position information acquisition unit 24. This processing is repeatedly executed until determination that the arrival at the destination is completed. In a case of determination that the arrival at the destination is completed, the process proceeds to step S12.

In step S12, the stay information acquisition unit 353 requests the smartphone 211 to collect stay information associated with the user. Specifically, the stay information acquisition unit 353 generates a stay information collection request signal requesting collection of stay information associated with the user. The stay information acquisition unit 353 transmits the stay information collection request signal to the smartphone 211 via the communication unit 22.

Thereafter, for example, the user leaves the vehicle 1 while carrying the smartphone 211, stays at a place of stay, and then returns to the vehicle 1. During this period, the smartphone 211 collects stay information associated with the place of stay, the time of stay, and the like of the user as will be described below.

In step S13, the occupant state detection unit 352 determines whether or not the user has returned to the vehicle 1. This processing is repeatedly executed until determination that the user has returned to the vehicle 1. Thereafter, in a case of determination that the user has returned to the vehicle 1, the process proceeds to step S14.

Note that a condition required for determination that the user has returned to the vehicle 1 is not limited to a specific condition. For example, determination that the user has returned to the vehicle 1 is made in a case where any human rides on the vehicle 1, a case where the vehicle 1 is powered on, a case where the communication unit 22 of the vehicle 1 is enabled to communicate with the smartphone 211 by near field communication, or other cases.

In step S14, the stay information acquisition unit 353 requests the smartphone 211 to send stay information associated with the user. Specifically, the stay information acquisition unit 353 generates a stay information request signal requesting stay information associated with the user. The stay information acquisition unit 353 transmits the stay information request signal to the smartphone 211 via the communication unit 22.

In response to this request, the smartphone 211 transmits the requested stay information associated with the user to the vehicle 1 as will be described below.

In step S15, the stay information acquisition unit 353 determines whether or not the stay information associated with the user has been acquired. In a case of reception of the stay information associated with the user from the smartphone 211 via the communication unit 22, the stay information acquisition unit 353 determines that the stay information associated with the user has been acquired, and the process proceeds to step S16.

In step S16, the air-conditioning control unit 355 transmits the stay information associated with the user to the cloud system 212, and requests sending of an air-conditioning control parameter. Specifically, the air-conditioning control unit 355 generates an air-conditioning control parameter request signal including stay information associated with the user and a user ID, and requesting sending of the air-conditioning control parameter. The air-conditioning control unit 355 transmits the air-conditioning control parameter request signal to the cloud system 212 via the communication unit 22 and the network 221.

In response to this request, the cloud system 212 calculates an air-conditioning control parameter associated with control of the air-conditioning system 315 on the basis of the stay information associated with the user as will be described below. The cloud system 212 transmits air-conditioning control parameter information including the air-conditioning control parameter to the vehicle 1 via the network 221.

In step S17, the air-conditioning control unit 355 acquires the air-conditioning control parameter from the cloud system 212. Specifically, the air-conditioning control unit 355 receives the air-conditioning control parameter information from the cloud system 212 via the network 221 and the communication unit 22.

In step S18, the air-conditioning control unit 355 starts air-conditioning control on the basis of the air-conditioning control parameter. For example, the air-conditioning control unit 355 starts the devices of the air-conditioning system 315 to control setting values of the respective devices of the air-conditioning system 315 (e.g., setting temperature, air volume, air direction) on the basis of the air-conditioning control parameter. Moreover, for example, the HVAC display 377 displays information indicating that the stay place adaptive mode is operating under control by the air-conditioning control unit 355.

In step S19, the occupant state detection unit 352 determines whether or not a state of the occupant meets a predetermined condition. For example, the occupant state detection unit 352 acquires sensor data indicating a detection result of a body temperature of the occupant from the IR sensor 335. In a case where the body temperature of the occupant falls within a predetermined range, the air-conditioning control unit 355 determines that the state of the occupant meets the predetermined condition. In a case where the body temperature of the occupant is out of the predetermined range, the air-conditioning control unit 355 determines that the state of the occupant does not meet the predetermined condition.

In a case where multiple occupants are present inside the vehicle herein, determination that the state of the occupant meets the predetermined condition may be made only when body temperatures of all the occupants fall within the predetermined range, for example. Alternatively, for example, determination that the state of the occupant meets the predetermined condition may be made when a body temperature of at least one of the occupants falls within the predetermined range. Instead, for example, determination that the state of the occupant meets the predetermined condition may be made when a body temperature of a specific occupant (e.g., the user of the smartphone 211) falls within the predetermined range.

Thereafter, in a case of determination that the temperature of the occupant does not meet the predetermined condition, the process proceeds to step S20.

In step S20, the air-conditioning control unit 355 determines whether or not a setting time of the stay place adaptive mode has elapsed. In a case where the air-conditioning control unit 355 determines that the setting time of the stay place adaptive mode has not elapsed yet from the start of air-conditioning control on the basis of the air-conditioning control parameter in step S18, the process proceeds to step S21.

Note that the setting time of the stay place adaptive mode is set to an upper limit of an execution time of a process for controlling the air-conditioning system 315 in the stay place adaptive mode on the basis of the air-conditioning control parameter calculated by the cloud system 212, for example. The setting time of the stay place adaptive mode may be either fixed by the air-conditioning system 315, or varied by the user, for example. Moreover, for example, the setting time of the stay place adaptive mode may be set according to the air-conditioning control parameter received from the cloud system 212.

In step S21, the air-conditioning control unit 355 determines whether or not a setting of the air-conditioning system 315 has been input by the user. In a case of determination that no setting of the air-conditioning system 315 has been input by the user, the process returns to step S19.

Thereafter, the processing from step S19 to step S21 is repeatedly executed until determination that the state of the occupant meets the predetermined condition in step S19, determination that the setting time of the stay place adaptive mode has elapsed in step S20, or determination that a setting of the air-conditioning system 315 has been input by the user in step S21.

Meanwhile, in a case where the user inputs a setting of the air-conditioning system 315 by using the operation unit 313 or the smartphone 211 in step S21, the air-conditioning control unit 355 determines that a setting of the air-conditioning system 315 has been input by the user, and the process proceeds to step S22.

In step S22, the air-conditioning mode of the vehicle 1 is set to the manual mode in step S22, as in the processing in step S7.

In step S23, the air-conditioning control unit 355 notifies the cloud system 212 of setting details of the air-conditioning system 315 set by the user. Specifically, the air-conditioning control unit 355 generates information including details set by the user in the processing of step S21 (e.g., setting values of the air-conditioning system 315) (hereinafter referred to as user air-conditioning setting information). For example, the user air-conditioning setting information includes the user ID and stay information associated with the user before riding on the vehicle 1 in addition to the setting details of the air-conditioning system 315 set by the user. The air-conditioning control unit 355 transmits the user air-conditioning setting information to the cloud system 212 via the communication unit 22 and the network 221.

Thereafter, the stay place adaptive air-conditioning control process ends.

Meanwhile, in a case of determination that the setting time of the stay place adaptive mode has elapsed in step S20, the process proceeds to step S24.

Moreover, in a case of determination that the state of the occupant meets the predetermined condition in step S19, the process proceeds to step S24.

Furthermore, in a case of determination that acquisition of the stay information associated with the user has failed in step S15, the process proceeds to step S24. For example, this case may occur in a situation where the on-vehicle air-conditioning control APP is not started in the smartphone 211 or other situations.

In step S24, the normal mode is set as in the processing in step S9.

Note that the air-conditioning control unit 355 may adopt, as the control method of the air-conditioning system 315, such a manner where the stay place adaptive mode gradually approaches the normal mode in a period from the start of air-conditioning control performed on the basis of the air-conditioning control parameter in step S18 to the setting of the normal mode in step S24, for example.

Moreover, such a case may occur where the process for controlling the air-conditioning system 315 according to the stay place adaptive mode is ended by the determination process in step S19 due to the state of the occupant, even before the elapse of the setting time of the stay place adaptive mode. Specifically, the execution time of the process for controlling the air-conditioning system 315 according to the stay place adaptive mode is shortened due to the state of the occupant.

Thereafter, the stay place adaptive air-conditioning control process ends.

### Process by Smartphone 211

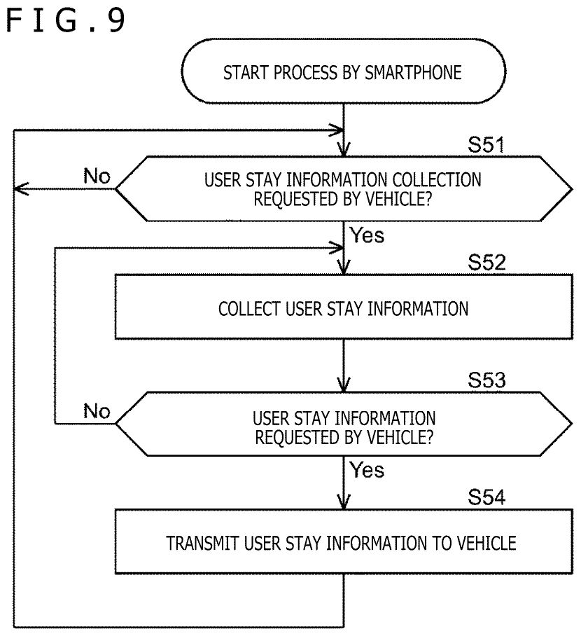

Described next with reference to a flowchart in FIG. 9 will be a process executed by the smartphone 211 according to the stay place adaptive air-conditioning control process performed by the vehicle 1 and illustrated in FIGS. 7 and 8.

For example, this process starts and ends in response to a start and an end of the on-vehicle air-conditioning control APP by the smartphone 211.

In step S51, the stay information acquisition unit 422 determines whether or not collection of the stay information associated with the user has been requested from the vehicle 1. This processing is repeatedly executed until determination that the vehicle 1 has requested collection of the stay information associated with the user. Thereafter, in a case of reception of a stay information collection request signal transmitted from the vehicle 1 in step S12 in FIG. 7 described above via the communication unit 405, the stay information acquisition unit 422 determines that collection of the stay information associated with the user has been requested from the vehicle 1, and the process proceeds to step S52.

In step S52, the stay information acquisition unit 422 collects the stay information associated with the user. For example, the stay information acquisition unit 422 acquires position information from the position information acquisition unit 402. For example, the position information includes a current position (e.g., latitude and longitude) of the user (the smartphone 211 carried by the user), and a time of acquisition of the position information (e.g., current time).

For example, the stay information acquisition unit 422 converts the current position of the user into a specific place on the basis of map information or the like. For example, the specific place includes a name of a building, a facility, a store, or the like where the user is present, a place name, a type of a place where the user is present, or the like. For example, the type of the place where the user is present is classified into any type of places such as a shopping center, a restaurant, a stadium, a gym, a pool, a mountain, the sea, and a road. The stay information acquisition unit 422 causes the storage unit 406 to store the position information including the place where the user is present, and the time.

In step S53, the stay information acquisition unit 422 determines whether or not the stay information associated with the user has been requested from the vehicle 1. In a case of determination that the stay information associated with the user has not been requested from the vehicle 1, the process returns to step S52.

Thereafter, in step S53, the processing in steps S52 and 53 is repeatedly executed until determination that the stay information associated with the user has been requested from the vehicle 1.

Meanwhile, in a case where a stay information request signal transmitted from the vehicle 1 in step S14 in FIG. 8 described above is received via the communication unit 405 in step S53, the stay information acquisition unit 422 determines that sending of the stay information associated with the user has been requested from the vehicle 1, and the process proceeds to step S54.

In step S54, the stay information acquisition unit 422 transmits the stay information associated with the user to the vehicle 1. Specifically, the stay information acquisition unit 422 generates the stay information indicating a transition of the place of stay of the user in time series, on the basis of position information accumulated in the storage unit 406 in a period up to the current time from the request of collection of the stay information associated with the user in step S51. Accordingly, the stay information includes information associated with the place of stay and the time of stay of the user, as well as a time of movement between the vehicle 1 and the place of stay or a time of movement between two places of stay. The stay information acquisition unit 422 transmits the stay information associated with the user to the vehicle 1 via the communication unit 405.

Thereafter, the process returns to step S51 to execute processing in and after step S51.

### Process by Cloud System 212

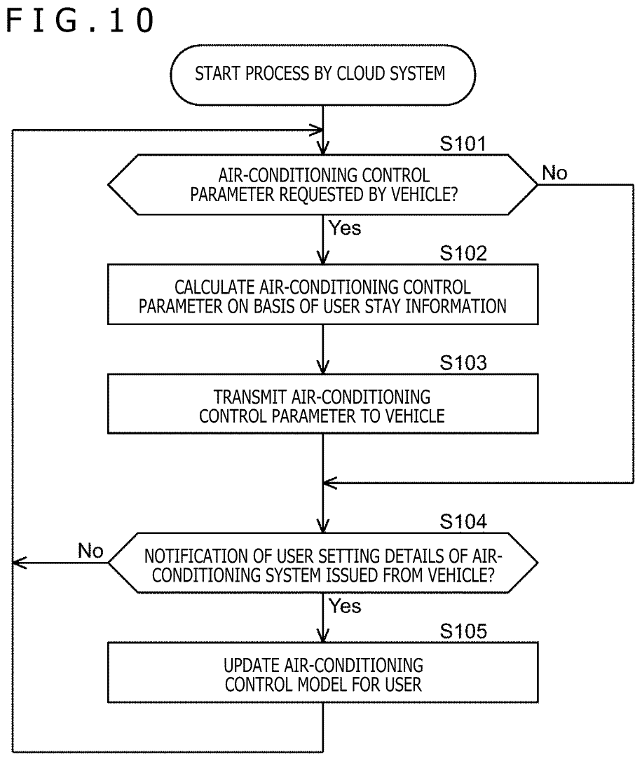

Described next with reference to a flowchart in FIG. 10 will be a process executed by the cloud system 212 according to the stay place adaptive air-conditioning control process performed by the vehicle 1 and illustrated in FIGS. 7 and 8.

In step S101, the air-conditioning control parameter calculation unit 521 determines whether or not sending of an air-conditioning control parameter has been requested from the vehicle 1. In a case of reception of an air-conditioning control parameter request signal transmitted from the vehicle 1 in step S16 in FIG. 8 via the network 221 and the communication unit 501, the air-conditioning control parameter calculation unit 521 determines that sending of an air-conditioning control parameter has been requested from the vehicle 1, and the process proceeds to step S102.

In step S102, the air-conditioning control parameter calculation unit 521 calculates the air-conditioning control parameter on the basis of stay information associated with the user.

For example, the air-conditioning control parameter calculation unit 521 calculates the air-conditioning control parameter on the basis of stay information associated with the user and included in the air-conditioning control parameter, by using an air-conditioning control model for the user accumulated in the cloud DB 503.

Specifically, for example, a body temperature of the user is estimated on the basis of the place of stay and the time of stay of the user, the time of movement from the place of stay to the vehicle 1, and others. Subsequently, a setting value of the air-conditioning system 315 expected to be requested by the user is calculated on the basis of the estimated body temperature of the user and a preference of the user for air-conditioning. Thereafter, an air-conditioning control parameter is generated on the basis of the determined setting value of the air-conditioning system 315. For example, the air-conditioning control parameter includes a setting value of the air-conditioning system 315 and a setting time of the stay place adaptive mode.

In step S103, the air-conditioning control parameter calculation unit 521 transmits the air-conditioning control parameter to the vehicle 1. Specifically, the air-conditioning control parameter calculation unit 521 generates air-conditioning control parameter information including the calculated air-conditioning control parameter. The air-conditioning control parameter calculation unit 521 transmits the air-conditioning control parameter information to the vehicle 1 via the communication unit 501 and the network 221.

Thereafter, the process proceeds to step S104.

Meanwhile, in a case of determination that the air-conditioning control parameter has not been requested from the vehicle 1 in step S101, the process proceeds to step S104 while skipping the processing in steps S102 and S103.

In step S104, the learning unit 522 determines whether or not a notification of setting details of the air-conditioning system 315 input by the user has been issued from the vehicle 1. In a case where the user air-conditioning setting information transmitted from the vehicle 1 in step S23 in FIG. 8 is received via the network 221 and the communication unit 501, the learning unit 522 determines that the notification of setting details of the air-conditioning system 315 input by the user has been issued from the vehicle 1, and the process proceeds to step S105.

In step S105, the learning unit 522 updates the air-conditioning control model for the user. For example, the learning unit 522 executes relearning of the air-conditioning control model for the user accumulated in the cloud DB 503, on the basis of the user air-conditioning setting information.

In this manner, for example, constitutions of the user (e.g., characteristics such as normal temperature and body temperature change) are more appropriately reflected in an algorithm for estimating the body temperature of the user on the basis of stay information associated with the user and included in the user air-conditioning setting information. Moreover, for example, preferences of the user are more appropriately reflected in an algorithm for calculating the air-conditioning control parameter on the basis of the estimated body temperature of the user.

The learning unit 522 accumulates the updated air-conditioning control model for the user in the cloud DB 503.

Thereafter, the process returns to step S101 to execute processing in and after step S101.

Meanwhile, in a case of determination that the notification of setting details of the air-conditioning system 315 input by the user has not been issued from the vehicle 1 in step S104, the process returns to step S101 to execute the processing in and after step S101.

In the manner described above, the air-conditioning system 315 is appropriately controlled after the user returns to the vehicle 1 from the place of stay, on the basis of stay information associated with the user before returning to the vehicle 1.

For example, in the middle of summer, the user returning to the vehicle 1 from a restaurant where air conditioning is sufficiently working is highly likely to have a lower body temperature even at a high outside temperature. In this situation, for example, a temperature higher than the setting temperature in the normal mode is set as the setting temperature of the air-conditioning system 315.

For example, the user returning to the vehicle 1 parked at a trailhead is highly likely to have a higher body temperature after mountain climbing even at a slightly lower outside temperature due to a high elevation of the tailhead. In this situation, for example, a temperature lower than the setting temperature in the normal mode is set as the setting temperature of the air-conditioning system 315.

For example, on a slightly cold day in spring or autumn, the user returning to the vehicle 1 is highly likely to have a higher body temperature after playing sports even at a slightly lower outside temperature. In this situation, for example, a temperature lower than the setting temperature in the normal mode is set as the setting temperature of the air-conditioning system 315.

For example, on a mild day in spring or autumn, the user returning to the vehicle 1 is highly likely to have a lower body temperature after participating in an outdoor event (e.g., outdoor concert, sports watching) even at a comfortable outside temperature. In this situation, for example, a temperature higher than the setting temperature in the normal mode is set as the setting temperature of the air-conditioning system 315.

As described above, the temperature and the like of the air-conditioning system 315 of the vehicle 1 are appropriately set according to a change of the body temperature of the user at the place of stay. In this manner, comfortableness of the user improves.

### 3. Modifications

Modifications of the embodiment of the present technology described above will hereinafter be described.

### Modification of Stay Information

Details of stay information may be varied as appropriate.

For example, the stay information is not necessarily required to include a time of stay. In this modification, for example, the air-conditioning control parameter calculation unit 521 of the cloud system 212 may estimate a body temperature of the user on the basis of only a place of stay of the user. In this case, accuracy lowers, but calculation of the air-conditioning control parameter is achievable on the basis of the place of stay.

For example, the vehicle 1 or the cloud system 212 may convert the current position of the user into a specific place.

For example, the stay information may include information other than information associated with a place of stay and a time of stay. Specifically, for example, the stay information may include information associated with a state of the place of stay, or a state of the user at the place of stay. For example, the state of the place of stay may include air temperature, humidity, wind speed, illuminance, and the like at the place of stay. For example, the state of the user at the place of stay may include details of a behavior of the user at the place of stay, and the like.

For example, information associated with the state of the place of stay or the state of the user at the place of stay is collected by the smartphone 211. For example, the smartphone 211 may detect the state of the place of stay or the state of the user at the place of stay by using the sensor unit 403. For example, the smartphone 211 may acquire information associated with the state of the place of stay by communicating with a sensor or a device equipped at the place of stay. For example, the smartphone 211 may acquire information associated with the state of the place of stay (e.g., meteorological information) from an external server or the like.

In addition, estimation accuracy of the body temperature of the user is allowed to improve by referring to the state of the place of stay or the state of the user at the place of stay. Accordingly, the air-conditioning control parameter can be more appropriately set.

For example, in a case where the stay information associated with the user is difficult to collect, the air-conditioning control parameter may be calculated on the basis of a destination set beforehand and designated as the place of stay of the user.

While described above has been the example which does not execute the stay place adaptive air-conditioning control process in a case where no destination is set, for example, the stay place adaptive air-conditioning control process may be executed even without setting of any destination. In this case, for example, the smartphone 211 may constantly collect stay information associated with the user, and calculate the air-conditioning control parameter on the basis of stay information obtained before the user rides on the vehicle 1. In this case, for example, the air-conditioning control parameter is appropriately set also at a place of departure on the basis of the place of stay or the like of the user before departure.

For example, a device carried by the user other than the smartphone 211 (e.g., wearable device) may collect stay information.

### Modification of Air-Conditioning Control Parameter

For example, the air-conditioning control parameter may include an estimated body temperature of the user instead of a setting value of the air-conditioning system 315. In this case, for example, the air-conditioning control unit 355 of the vehicle 1 controls a setting value of the air-conditioning system 315 on the basis of the estimated body temperature of the user.

For example, the air-conditioning control parameter calculation unit 521 of the cloud system 212 may directly calculate the air-conditioning control parameter on the basis of stay information associated with the user without estimating the body temperature of the user.

For example, the air-conditioning control parameter calculation unit 521 of the cloud system 212 may calculate the air-conditioning control parameter by using a predetermined algorithm without using the air-conditioning control model.

### Modification of Process Allocation

Allocation of processes performed by the air-conditioning control system 201 may be varied as appropriate.

For example, the vehicle 1 or the smartphone 211 may execute calculation of the air-conditioning control parameter. In this case, for example, the cloud system 212 may provide the air-conditioning control model for the vehicle 1 or the smartphone 211, or the vehicle 1 or the smartphone 211 may execute a process for learning the air-conditioning control model. In the latter case, for example, the cloud system 212 may be eliminated from the air-conditioning control system 201.

For example, the vehicle 1 may collect the stay information. Specifically, in a case where the user stays at a place viewable from the vehicle 1, for example, the stay information acquisition unit 353 of the vehicle 1 may collect the stay information on the basis of surrounding image data obtained by the outside-vehicle camera 337 of the vehicle 1.

For example, the stay information associated with the user may directly be transmitted from the smartphone 211 to the cloud system 212 without passing through the vehicle 1.

### Modification of Application Range of Present Technology

For example, the present technology is also applicable to control of an air-conditioning system equipped inside a moving body carrying a human and other than a vehicle. For example, the present technology is applicable to control of an air-conditioning system equipped inside a moving body carrying a smaller number of humans, such as a personal mobility, a small airplane, a small boat, and a helicopter.

For example, the present technology is also applicable to control of an air-conditioning system equipped in a space other than a moving body. For example, the present technology is also applicable to control of an air-conditioning system equipped inside a building such as a private house, or inside a room. Moreover, for example, the place of stay may include not only a place outside a building but also another place inside a building. For example, in a case where the user moves from a place of stay, such as a restaurant and a conference room in a hotel, to his or her room in the hotel, an air-conditioning system in his or her room may be controlled on the basis of the place of stay or the like before movement to the room, for example.

### 4. Others

### Configuration Example of Computer

A series of processes described above may also be executed either by hardware or by software. In a case where the series of processes are executed by software, a program constituting the software is installed in a computer. Examples of the computer herein include a computer incorporated in dedicated hardware, a computer capable of executing various functions under various programs installed in the computer, such as a general-purpose personal computer, and other computers.

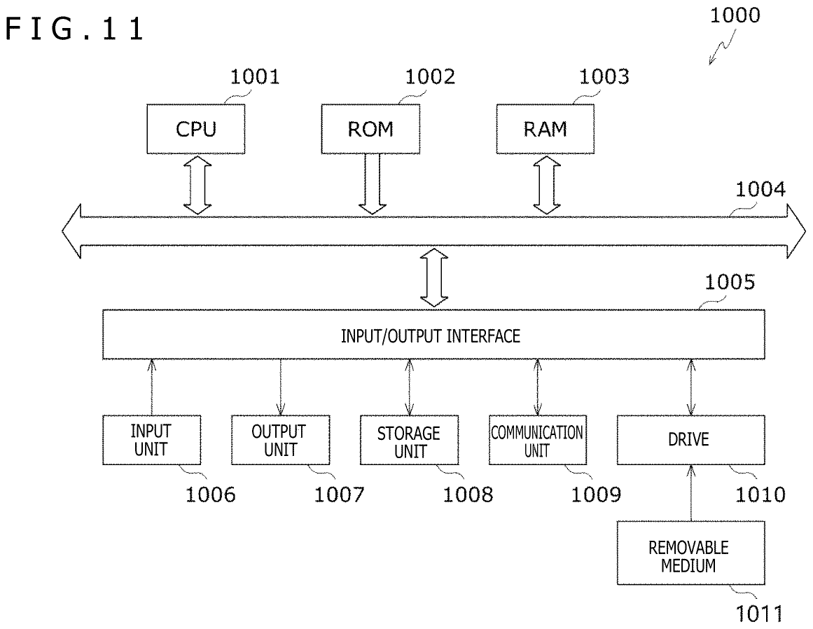

FIG. 11 is a block diagram illustrating a hardware configuration example of a computer which executes the series of processes described above under a program.

A computer 1000 includes a CPU (Central Processing Unit) 1001, a ROM (Read Only Memory) 1002, and a RAM (Random Access Memory) 1003 connected to each other via a bus 1004.

An input/output interface 1005 is further connected to the bus 1004. An input unit 1006, an output unit 1007, a storage unit 1008, a communication unit 1009, and a drive 1010 are connected to the input/output interface 1005.

The input unit 1006 includes an input switch, a button, a microphone, an imaging element, and others. The output unit 1007 includes a display, a speaker, and others. The storage unit 1008 includes a hard disk, a non-volatile memory, and others. The communication unit 1009 includes a network interface and others. The drive 1010 drives a removable medium 1011 such as a magnetic disk, an optical disk, a magneto-optical disk, and a semiconductor memory.

According to the computer 1000 configured as described above, for example, the CPU 1001 loads a program recorded in the storage unit 1008 into the RAM 1003 via the input/output interface 1005 and the bus 1004, and executes the loaded program to perform the series of processes described above.

For example, the program executed by the computer 1000 (CPU 1001) is allowed to be recorded in the removable medium 1011 as a package medium or the like, and provided in this form. Moreover, the program is allowed to be provided via a wired or wireless transfer medium such as a local area network, the Internet, and digital satellite broadcasting.

The program of the computer 1000 is allowed to be installed into the storage unit 1008 via the input/output interface 1005 from the removable medium 1011 attached to the drive 1010. Alternatively, the program is allowed to be received by the communication unit 1009 via a wired or wireless transfer medium, and installed into the storage unit 1008. Instead, the program is allowed to be installed beforehand in the ROM 1002 or the storage unit 1008.

Note that the program executed by the computer may be either a program where processes are performed in time series in the order described in the present description, or a program where processes are performed in parallel, or at necessary timing such as an occasion when a call is made.

Moreover, a system in the present description refers to a set of multiple constituent elements (e.g., devices, modules (parts)), and all of the constituent elements are not required to be included in an identical housing. Accordingly, multiple devices accommodated in different housings and connected to each other via a network and one device which includes multiple modules in one housing are both regarded as a system.

Furthermore, embodiments of the present technology are not limited to the embodiment described above, and may be modified in various manners without departing from the subject matters of the present technology.

For example, the present technology may be practiced as a configuration of cloud computing where one function is shared by multiple devices and performed by the devices in cooperation with each other via a network.

In addition, the steps explained with reference to the flowcharts presented above may be executed by one device, or may be shared and executed by multiple devices.

Furthermore, in a case where one step includes multiple processes, the multiple processes included in the one step may be executed by one device, or may be shared and executed by multiple devices.

### Configuration Combination Example

The present technology may have the following configurations.

(1)

An air-conditioning control device including:
a parameter calculation unit that calculates an air-conditioning control parameter associated with control of an air-conditioning system, on the basis of stay information that includes a place of stay of a user before the user moves to a space where the air-conditioning system is provided.
   (2)

The air-conditioning control device according to (1) above, in which
the stay information further includes a time of stay of the user at the place of stay.
   (3)

The air-conditioning control device according to (1) or (2) above, in which
the air-conditioning control parameter includes a setting value of the air-conditioning system.
   (4)

The air-conditioning control device according to (3) above, in which
the air-conditioning control parameter further includes an execution time of a process for controlling the air-conditioning system, on the basis of the air-conditioning control parameter.
   (5)

The air-conditioning control device according to any one of (1) to (4) above, in which
the parameter calculation unit estimates a body temperature of the user on the basis of the stay information.
   (6)

The air-conditioning control device according to (5) above, in which
the parameter calculation unit calculates a setting value of the air-conditioning system on the basis of the estimated body temperature of the user.
   (7)

The air-conditioning control device according to (5) or (6) above, in which
the air-conditioning control parameter includes the estimated body temperature of the user.
   (8)

The air-conditioning control device according to any one of (1) to (7) above, further including:
a communication unit that transmits the air-conditioning control parameter to a device that controls the air-conditioning system.
   (9)

The air-conditioning control device according to (8) above, in which
the device includes a moving body.
   (10)

The air-conditioning control device according to (9) above, in which
the moving body includes a vehicle.
   (11)

The air-conditioning control device according to any one of (1) to (10) above, in which
the parameter calculation unit calculates the air-conditioning control parameter by using an air-conditioning control model that calculates the air-conditioning control parameter.
   (12)

The air-conditioning control device according to (11) above, further including:
a learning unit that updates the air-conditioning control model on the basis of setting details input to the air-conditioning system from the user in a case where the air-conditioning system is controlled on the basis of the air-conditioning control parameter.
   (13)

The air-conditioning control device according to any one of (1) to (12) above, further including:
an air-conditioning control unit that controls the air-conditioning system on the basis of the air-conditioning control parameter.
   (14)

The air-conditioning control device according to (13) above, in which
the air-conditioning control unit further controls an execution time of a process for controlling the air-conditioning system on the basis of the air-conditioning control parameter.
   (15)

The air-conditioning control device according to (14) above, in which
the air-conditioning control unit controls the execution time on the basis of a state of the user.
   (16)

The air-conditioning control device according to any one of (1) to (15) above, further including:
a stay information acquisition unit that acquires the stay information.
   (17)

The air-conditioning control device according to any one of (1) to (16) above, in which
the space includes an interior of a moving body.
   (18)

The air-conditioning control device according to (17) above, in which
the moving body includes a vehicle.
   (19)

An air-conditioning control method including:
by an air-conditioning control device, calculating an air-conditioning control parameter associated with control of an air-conditioning system, on the basis of stay information that includes a place of stay of a user before the user moves to a space where the air-conditioning system is provided.
   (20)

A program that causes a computer to execute:
a process of calculating an air-conditioning control parameter associated with control of an air-conditioning system, on the basis of stay information that includes a place of stay of a user before the user moves to a space where the air-conditioning system is provided.

Note that advantageous effects to be offered are not limited to those presented in the present description only by way of example. Accordingly, other advantageous effects may be produced.

### Reference Signs List

1: Vehicle
201: Air-conditioning control system
211: Smartphone
212: Cloud system
221: Network
311: Sensor unit
312: Navigation device
313: Operation unit
314: Control unit
315: Air-conditioning system
351: Environment information detection unit
352: Occupant state detection unit
353: Stay information acquisition unit
354: Mode setting unit
355: Air-conditioning control unit
371: A/C system
372: Heater
373: Blower
374: Louver actuator
375: Seat ventilation
376: Seat heater
377: HVAC display
401: Operation unit
402: Position information acquisition unit
403: Sensor unit
404: On-vehicle air-conditioning control unit
405: Communication unit
421: Setting unit
422: Stay information acquisition unit
501: Communication unit
502: On-vehicle air-conditioning control unit
503: Cloud DB
521: Air-conditioning control parameter calculation unit
522: Learning unit

1. An air-conditioning control device comprising:
a parameter calculation unit that calculates an air-conditioning control parameter associated with control of an air-conditioning system, on a basis of stay information that includes a place of stay of a user before the user moves to a space where the air-conditioning system is provided.

2. The air-conditioning control device according to claim 1, wherein
the stay information further includes a time of stay of the user at the place of stay.

3. The air-conditioning control device according to claim 1, wherein
the air-conditioning control parameter includes a setting value of the air-conditioning system.

4. The air-conditioning control device according to claim 3, wherein
the air-conditioning control parameter further includes an execution time of a process for controlling the air-conditioning system, on a basis of the air-conditioning control parameter.

5. The air-conditioning control device according to claim 1, wherein
the parameter calculation unit estimates a body temperature of the user on the basis of the stay information.

6. The air-conditioning control device according to claim 5, wherein
the parameter calculation unit calculates a setting value of the air-conditioning system on a basis of the estimated body temperature of the user.

7. The air-conditioning control device according to claim 5, wherein
the air-conditioning control parameter includes the estimated body temperature of the user.

8. The air-conditioning control device according to claim 1, further comprising:
a communication unit that transmits the air-conditioning control parameter to a device that controls the air-conditioning system.

9. The air-conditioning control device according to claim 8, wherein
the device includes a moving body.

10. The air-conditioning control device according to claim 9, wherein
the moving body includes a vehicle.

11. The air-conditioning control device according to claim 1, wherein
the parameter calculation unit calculates the air-conditioning control parameter by using an air-conditioning control model that calculates the air-conditioning control parameter.

12. The air-conditioning control device according to claim 11, further comprising:
a learning unit that updates the air-conditioning control model on the basis of setting details input to the air-conditioning system from the user in a case where the air-conditioning system is controlled on a basis of the air-conditioning control parameter.

13. The air-conditioning control device according to claim 1, further comprising:
an air-conditioning control unit that controls the air-conditioning system on a basis of the air-conditioning control parameter.

14. The air-conditioning control device according to claim 13, wherein
the air-conditioning control unit further controls an execution time of a process for controlling the air-conditioning system on the basis of the air-conditioning control parameter.

15. The air-conditioning control device according to claim 14, wherein
the air-conditioning control unit controls the execution time on a basis of a state of the user.

16. The air-conditioning control device according to claim 1, further comprising:
a stay information acquisition unit that acquires the stay information.

17. The air-conditioning control device according to claim 1, wherein
the space includes an interior of a moving body.

18. The air-conditioning control device according to claim 17, wherein
the moving body includes a vehicle.

19. An air-conditioning control method comprising:
by an air-conditioning control device, calculating an air-conditioning control parameter associated with control of an air-conditioning system, on a basis of stay information that includes a place of stay of a user before the user moves to a space where the air-conditioning system is provided.

20. A program that causes a computer to execute:
a process of calculating an air-conditioning control parameter associated with control of an air-conditioning system, on a basis of stay information that includes a place of stay of a user before the user moves to a space where the air-conditioning system is provided.
